(19) United States
(12) Patent Application Publication
(10) Pub. No.: US 2014/0368721 A1
(43) Pub. Date: Dec. 18, 2014

(54) IMAGE CAPTURE DEVICE AND METHOD

(71) Applicants: Sintai Optical (Shenzhen) Co., Ltd., Shenzhen City (CN); Asia Optical International Ltd., Tortola, B.V.I. (GB)

(72) Inventor: Chikashi Tsuchiya, Shenzhen City (CN)

(73) Assignees: ASIA OPTICAL INTERNATIONAL LTD., Tortola, B.V.I. (GB); SINTAI OPTICAL (SHENZHEN) CO., LTD., Shenzhen City (CN)

(21) Appl. No.: 14/306,773

(22) Filed: Jun. 17, 2014

(30) Foreign Application Priority Data
Jun. 18, 2013 (TW) 102121495

(51) Int. Cl. H04N 5/225; H04N 5/232

(52) U.S. Cl. CPC H04N 5/2254; H04N 5/23293
USPC 348/333.06

(57) ABSTRACT

An image capture device includes a device body, a rotary support, a display, and a lens. The rotary support is rotatably connected to a bottom of the device body. The display is rotatably connected to the rotary support. The lens defines an optical axis, wherein the display lies on an imaginary plane when the display separates from the device body, and the optical axis extends in the imaginary plane. An image capturing method includes the steps of rotating a display of an image capture device; positioning the display with respect to a device body of the image capture device; adjusting a location and an orientation of the image capture device so that an imaginary plane on which the display lies can extend to a target object; and capturing an image of the target object by the image capture device.

### RELATED APPLICATION

This application claims the benefit of foreign priority to Taiwan Invention Patent Application No. TW102121495, filed on Jun. 18, 2013, the entire contents of which are incorporated herein by reference for all purposes.

### BACKGROUND OF THE INVENTION

1. Field of the Invention

The invention relates to an image capture device and method.

2. Description of the Related Art

Cameras have become popular technical products. In operation, the user needs to take a view before taking photos. Currently, a camera is provided with a display in addition to a conventional eyepiece, facilitating the user to view the target object.

A display is able to significantly facilitate the viewing. In some situations, however, viewing target objects is still a little inconvenient. For instance, the user needs to lower himself/herself as much as possible or even get down on the ground to view the target object when the camera is located on the ground to take photos.

### BRIEF SUMMARY OF THE INVENTION

The invention provides an image capture device to solve the described problem. The image capture device in accordance with an exemplary embodiment of the invention includes a device body, a rotary support, a display, and a lens. The device body includes a bottom. The rotary support is rotatably connected to the bottom of the device body. The display is rotatably connected to the rotary support so that the display can contact the device body or separate from the device body via rotation of the rotary support, wherein a rotational angle of the display with respect to the rotary support is equal to or greater than 135°. The lens defines an optical axis, wherein the display lies on an imaginary plane when the display separates from the device body, and the optical axis extends in the imaginary plane. Thus, the orientation of the display is adjustable to suit the user's posture. The user does not need to accommodate himself/herself to the camera. Therefore, taking photos is more convenient.

In another exemplary embodiment, the image capture device further includes a limit mechanism configured to limit rotation of the rotary support with respect to the device body.

In yet another exemplary embodiment, the limit mechanism includes an inclined surface formed on the display, and the rotation of the rotary support with respect to the device body is stopped when the inclined surface is propped against the device body.

In another exemplary embodiment, the limit mechanism includes a groove formed on the device body and a limit support connecting the rotary support and the device body. The limit support includes a shaft connected to the rotary support and a slider movably disposed in the groove. The groove includes an end. The rotation of the rotary support with respect to the device body is stopped when the slider is propped against the end of the groove.

The invention also provides an image capture device. The image capture device in accordance with an exemplary embodiment of the invention includes a device body, a rotary support, a display, and a positioning mechanism. The device body includes a bottom. The rotary support is rotatably connected to the bottom of the device body. The display is rotatably connected to the rotary support so that the display can contact the device body or separate from the device body via rotation of the rotary support, wherein a rotational angle of the display with respect to the rotary support is equal to or greater than 135°. The positioning mechanism is configured to keep the rotational angle of the display with respect to the rotary support. The positioning mechanism includes a first protrusion, a second protrusion, and a post. The rotary support includes an end. The first protrusion and the second protrusion are disposed at the end of the rotary support. The post is disposed on the display. The rotational angle of the display with respect to the rotary support is kept when the post is positioned between the first protrusion and the second protrusion,

The invention also provides an image capturing method. The image capturing method in accordance with an exemplary embodiment of the invention includes the steps of rotating a display of an image capture device; positioning the display with respect to a device body of the image capture device; adjusting a location and an orientation of the image capture device so that an imaginary plane on which the display lies can extend to a target object; and capturing an image of the target object by the image capture device.

In another exemplary embodiment, the imaginary plane and the device body have a maximum angle of 90° therebetween.

In yet another exemplary embodiment, the display is positioned with respect to a device body of the image capture device by a positioning mechanism.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 depicts rotation of a display and a rotary support with respect to a device body of an image capture device in accordance with the invention;

FIG. 2 depicts rotation of the display with respect to the rotary support in accordance with the invention;

FIGS. 3 and 4 depict operation of a limit mechanism during rotation of the display and the rotary support of the image capture device in accordance with the invention;

FIGS. 5 and 6 depict operation of a positioning mechanism during rotation of the display of the image capture device in accordance with the invention;

FIG. 7 depicts operation of capturing an image in accordance with the invention; and

FIG. 8 is a flow chart of an image capturing method in accordance with the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

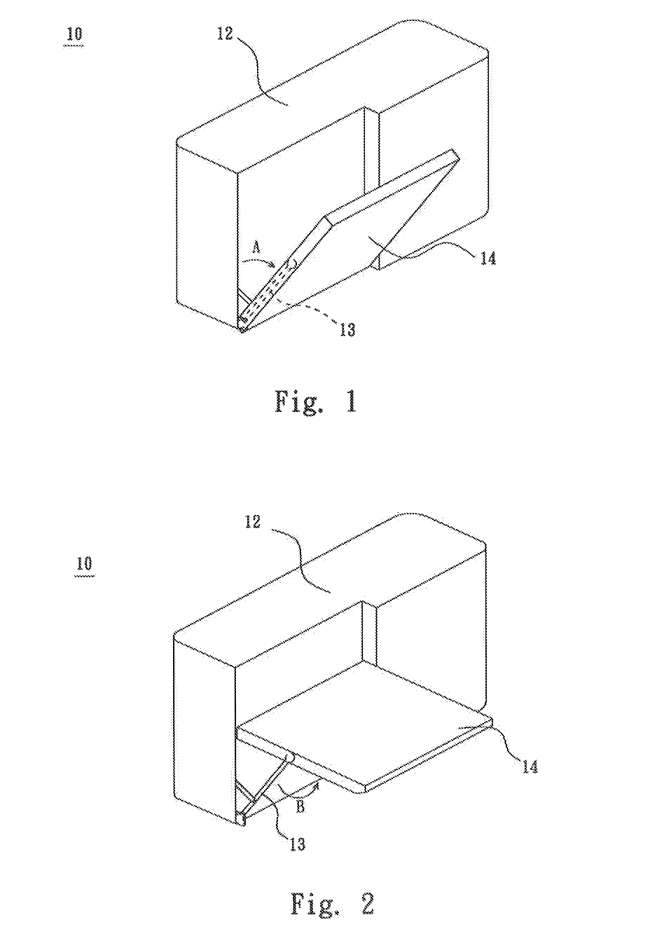

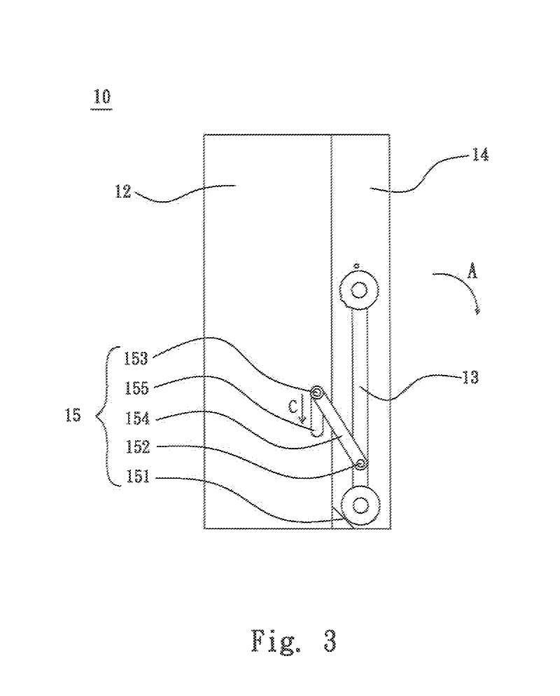

Referring to FIGS. 1 and 2, an image capture device 10 of the invention (e.g. a still camera, a video camera, etc.) includes a device body 12, a rotary support 13 rotatably connected to the bottom of the device body 12, and a display 14 rotatably connected to the rotary support 13. When not in use, the display 14 contacts the device body 12. In operation, the orientation of the display 14 can be changed by rotating the display 14 and the rotary support 13 with respect to the device body 12 in direction A, and then rotating the display 14 with respect to rotary support 13 in direct B.

According to the above operation, the orientation of the display 14 can be changed to suit the user's posture. The user does not need to accommodate himself/herself to the camera. Therefore, taking photos is more convenient.

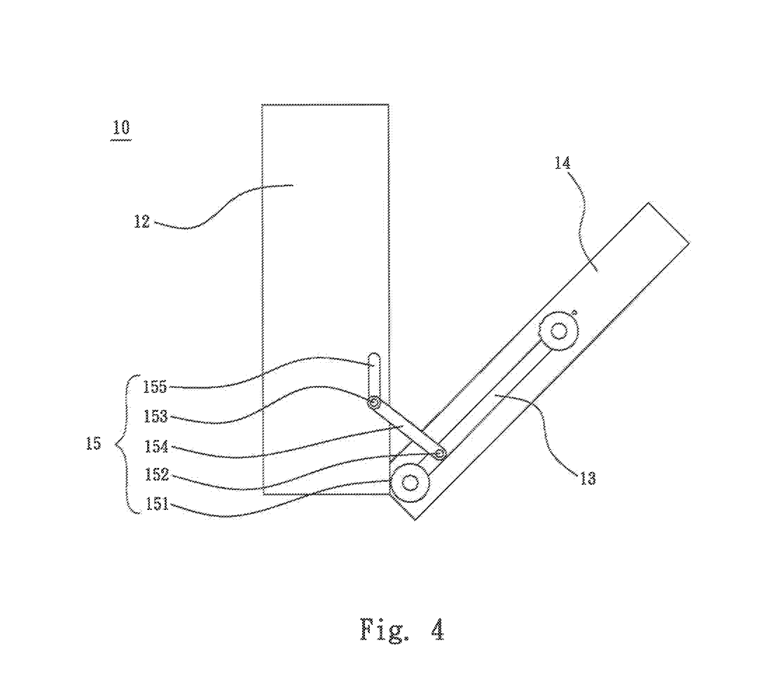

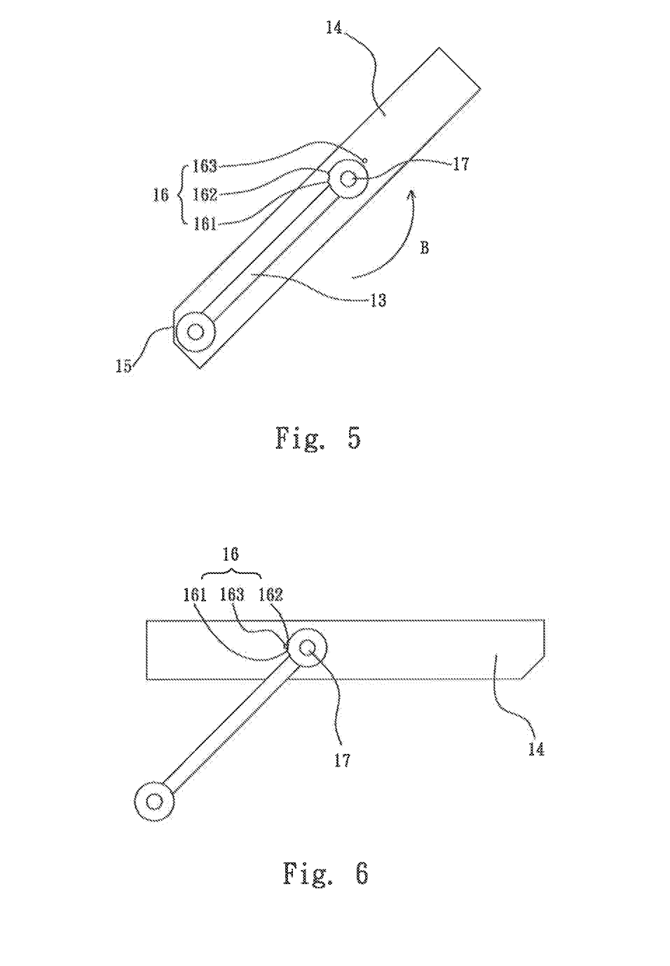

As shown in FIGS. 3 and 4, a rotational angle of the rotary support 13 with respect to the device body 12 is limited in a rage of, for example, 0°-45° by a limit mechanism 15. As shown in FIGS. 5 and 6, the rotation of the display 14 is stopped by a positioning mechanism 16 when the rotational angle of the display 14 with respect to the rotary support 13 reaches 135°. Accordingly, a maximum rotational angle of the display 14 with respect to the device body 12 is 90°. The detail is described as follows.

FIG. 3 depicts the limit mechanism 15 which includes an inclined surface 151 formed on the bottom the display 14, a groove 155 disposed in the device body 12, and a limit support 154 connected between the rotary support 13 and the device body 12. A shaft 152 disposed at an end of the limit support 154 is connected to the rotary support 13, while a slider 153 is disposed at the other end of the limit support 154. When the display 14 is rotated in direction A, the limit support 154 is rotated with respect to the rotary support 13 via the shaft 152 and the slider 153 travels downward in the groove 155 in direction C until reaching an end of the groove 155. When the slider 153 reaches the end of the groove 155, the inclined surface 151 on the bottom of the display 14 is propped against the device body 12 as shown in FIG. 4.

As described, both the limit support 154 and the inclined surface 151 provide the limiting function, thereby limiting the rotational angle of the rotary support 13 with respect to the device body 12 in the range of 0°-45°. It is understood that the limit support 154 operates independent from the inclined surface 151. Therefore, the limit mechanism 15 can still works when either of the limit support 154 and the inclined surface 151 is provided and the other is omitted.

FIG. 5 depicts the positioning mechanism 16 which includes a first protrusion 161, a second protrusion 162, and a post 163. The first protrusion 161 and the second protrusion 162 are disposed on a shaft 17 at an end of the rotary support 13. The post 163 is disposed on the display 14. In operation, the display 14 is rotated with respect to the rotary support 13 in direction B. The post 163 follows the display 14 to rotate, travels over the second protrusion 162, and is positioned between the first protrusion 161 and the second protrusion 162, where as shown in FIG. 6 the rotational angle of the display 14 with respect to the rotary support 13 reaches 135°. It is noted that the post 163 is able to cross the first protrusion 162 by an external force so that the rotational angle of the display 14 with respect to the rotary support 13 exceeds 135°.

As described, the invention provides a positioning mechanism 16 to position the display 14 and prevent accidental rotation of the display 14. On the other hand, if the display 14 is retained in position only via the inner frictions of the shaft 17 rather than the positioning mechanism 16, then the shaft 17 may become loose after a long time of use and fail to retain the display 14 in position that irritates the user.

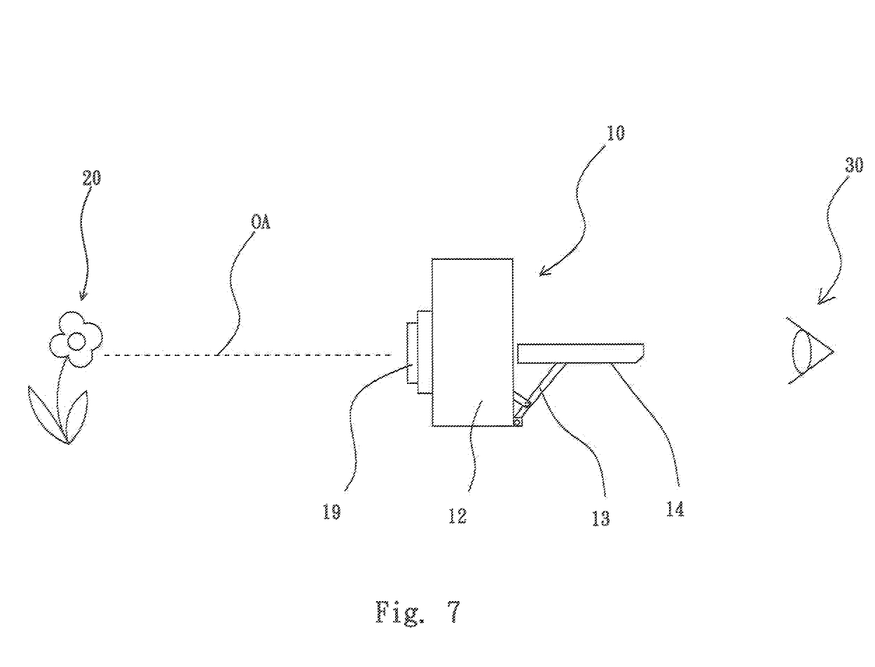

Referring to FIG. 7, an imaginary plane on which the display 14 lies can extend to a target object along the optical axis OA of a lens 19 when the display 14 is rotated to separate from the device body 12. By means of such an arrangement, the invention provides an image capturing method differing from the prior art. The display 14 can aid the user to find a view when the display 14 is rotated to separate from the device body 12 as shown in FIG. 7 and has not been restored for some reasons (e.g. the user wants to take a photo of the next target object in hurry). Specifically, the user can move the image capture device 10 to quickly change the location and orientation thereof until an imaginary plane on which the display 14 lies extends to the target object 20, wherein the imaginary plane and the device body 12 have an angle of 90° therebetween. Under such a circumstance, the lens 19 is already aimed at the target object 20, and the user can take a photo of the target object 20 without viewing the display 14.

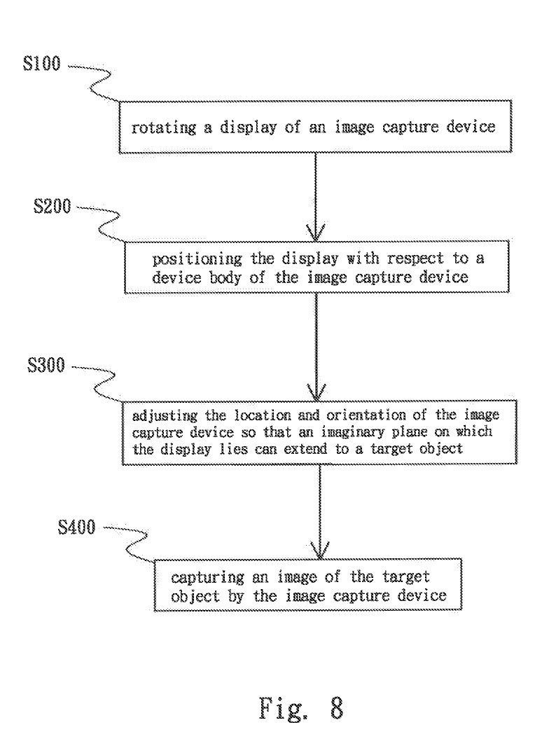

The above photographing process can be illustrated by FIG. 8. In step S100, the display 14 of the image capture device 10 is rotated in directions A and B. In step S200, the display 14 is retained in position with respect to the device body 12 by the limit mechanism 15 and the positioning mechanism 16. In S300, the image capture device 10 is moved to adjust the locations and orientations thereof so that an imaginary plane on which the display 14 lies can extend to a target object 20. Thus, the lens 19 is aimed at the target object 20. In S400, an image of the target object 20 is captured by the image capture device 10 to complete the photographing work.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An image capture device, comprising:
a device body comprising a bottom;
a rotary support rotatably connected to the bottom of the device body;
a display rotatably connected to the rotary support so that the display can contact the device body or separate from the device body via rotation of the rotary support, wherein a rotational angle of the display with respect to the rotary support is equal to or greater than 135°; and
a lens which defines an optical axis, wherein the display lies on an imaginary plane when the display separates from the device body, and the optical axis extends in the imaginary plane.

2. The image capture device as claimed in claim 1, further comprising a limit mechanism configured to limit rotation of the rotary support with respect to the device body.

3. The image capture device as claimed in claim 2, wherein the limit mechanism comprises an inclined surface formed on the display, and the rotation of the rotary support with respect to the device body is stopped when the inclined surface is propped against the device body.

4. The image capture device as claimed in claim 2, wherein the limit mechanism comprises a groove formed on the device body and a limit support connecting the rotary support and the device body, the limit support comprises a shaft connected to the rotary support and a slider movably disposed in the groove, the groove comprises an end, and the rotation of the rotary support with respect to the device body is stopped when the slider is propped against the end of the groove.

5. An image capture device, comprising:
a device body comprising a bottom;
a rotary support rotatably connected to the bottom of the device body;
a display rotatably connected to the rotary support so that the display can contact the device body or separate from the device body via rotation of the rotary support, wherein a rotational angle of the display with respect to the rotary support is equal to or greater than 135°; and
a positioning mechanism configured to keep the rotational angle of the display with respect to the rotary support, wherein the positioning mechanism comprises a first protrusion, a second protrusion, and a post, the rotary support comprises an end, the first protrusion and the second protrusion are disposed at the end of the rotary support, the post is disposed on the display, and the rotational angle of the display with respect to the rotary support is kept when the post is positioned between the first protrusion and the second protrusion.

6. An image capturing method, comprising:
rotating a display of an image capture device;
positioning the display with respect to a device body of the image capture device;
adjusting a location and an orientation of the image capture device so that an imaginary plane on which the display lies can extend to a target object; and
capturing an image of the target object by the image capture device.

7. The image capturing method as claimed in claim 6, wherein the imaginary plane and the device body have a maximum angle of 90° therebetween.

8. The image capturing method as claimed in claim 6, wherein the display is positioned with respect to a device body of the image capture device by a positioning mechanism.
